(19) United States
(12) Patent Application Publication
(10) Pub. No.: US 2014/0331142 A1
(43) Pub. Date: Nov. 6, 2014

(54) METHOD AND SYSTEM FOR RECOMMENDING CONTENTS

(71) Applicant: TENCENT TECHNOLOGY (SHENZHEN) COMPANY LIMITED, Shenzhen (CN)

(72) Inventor: NING LI, Shenzhen (CN)

(73) Assignee: TENCENT TECHNOLOGY (SHENZHEN) COMPANY LIMITED, Shenzhen (CN)

(21) Appl. No.: 14/179,814

(22) Filed: Feb. 13, 2014

Related U.S. Application Data
(63) Continuation of application No. PCT/CN2013/088771, filed on Dec. 6, 2013.

(30) Foreign Application Priority Data
May 6, 2013 (CN) 201310162934.0

(51) Int. Cl. G06F 17/30; H04L 29/08

(52) U.S. Cl. CPC G06F 17/30899; H04L 67/02; G06F 17/30887
USPC 715/738

(57) ABSTRACT

A content recommendation method is provided for a terminal having a browser client. The method includes analyzing a webpage being browsed by a user and determining one or more TAGs corresponding to the webpage, obtaining a list of uniform resource locators (URLs) corresponding to the TAGs from a preconfigured TAG database, and recommending contents related to the TAGs to the user based on the contents of the websites corresponding to the URL list.

### CROSS-REFERENCES TO RELATED APPLICATIONS

This application is a continuation application of PCT Patent Application No. PT/CN2013/088771, filed on Dec. 6, 2013, which claims priority of Chinese Patent Application No. 201310162934.0, filed on May 6, 2013, the entire contents of all of which are incorporated by reference herein.

### FIELD OF THE INVENTION

The present invention generally relates to the Internet technologies and, more particularly, to a method and system for recommending web contents.

### BACKGROUND

With the development of the Internet technologies, more and more people conduct activities through the Internet, such as reading news, playing games, chatting, and handling e-mail, etc. Especially with the rapid growth of the Internet these days, information via the Internet becomes more timely and accurate, and more and more users read news through the Internet every day.

Currently, to facilitate the user to read the news, many websites have adopted the topic based news recommendation feature to recommend relevant news to the users, such that the users can see other news related to a particular topic on a visiting website. For example, the visiting website can associate several relevant news and recommended them together to the user. The user can open each of the several relevant news recommended by the visiting website in the web browser, so as to view the contents.

However, when using the current topic-based news recommendation methods, the recommendation is often done within the scope of the visiting website, and the range of the recommended contents is thus limited. If the user wants to know contents of related topics from websites other than the visiting website, the user may need to reopen the other websites to browse the contents. Thus, it may be inconvenient for the user to view the contents, the effectiveness of the content recommendation may be poor, and the efficiency of the content recommendation may be low.

The disclosed method and system are directed to solve one or more problems set forth above and other problems.

### BRIEF SUMMARY OF THE DISCLOSURE

One aspect of the present disclosure includes a content recommendation method for a terminal having a browser client. The method includes analyzing a webpage being browsed by a user and determining one or more TAGs corresponding to the webpage, obtaining a list of uniform resource locators (URLs) corresponding to the TAGs from a preconfigured TAG database, and recommending contents related to the TAGs to the user based on the contents of the websites corresponding to the URL list.

Another aspect of the present disclosure includes a content recommendation system for recommending contents for a terminal having a browser client. The content recommendation system includes a determining module, an obtaining module, and a recommendation module. The determining module is configured to analyze a webpage being browsed by a user to determine one or more TAGs corresponding to the webpage. The obtaining module is configured to obtain a list of uniform resource locators (URLs) corresponding to the TAGs from a preconfigured TAG database. Further, the recommendation module is configured to recommend contents related to the TAGs to the user based on the contents of the websites corresponding to the URL list.

Other aspects of the present disclosure can be understood by those skilled in the art in light of the description, the claims, and the drawings of the present disclosure.

### BRIEF DESCRIPTION OF THE DRAWINGS

FIG. 1 illustrates an exemplary content recommendation process consistent with the disclosed embodiments;

FIG. 2 illustrates another exemplary content recommendation process consistent with the disclosed embodiments;

FIG. 3 illustrates another exemplary content recommendation process consistent with the disclosed embodiments;

FIG. 4 illustrates an exemplary content recommendation system consistent with the disclosed embodiments;

FIG. 5 illustrates another exemplary content recommendation system consistent with the disclosed embodiments;

FIG. 6 illustrates another exemplary content recommendation system consistent with the disclosed embodiments;

FIG. 7 illustrates an exemplary operating environment incorporating certain disclosed embodiments; and

FIG. 8 illustrates a block diagram of an exemplary computer system consistent with the disclosed embodiments.

### DETAILED DESCRIPTION

Reference will now be made in detail to exemplary embodiments of the invention, which are illustrated in the accompanying drawings.

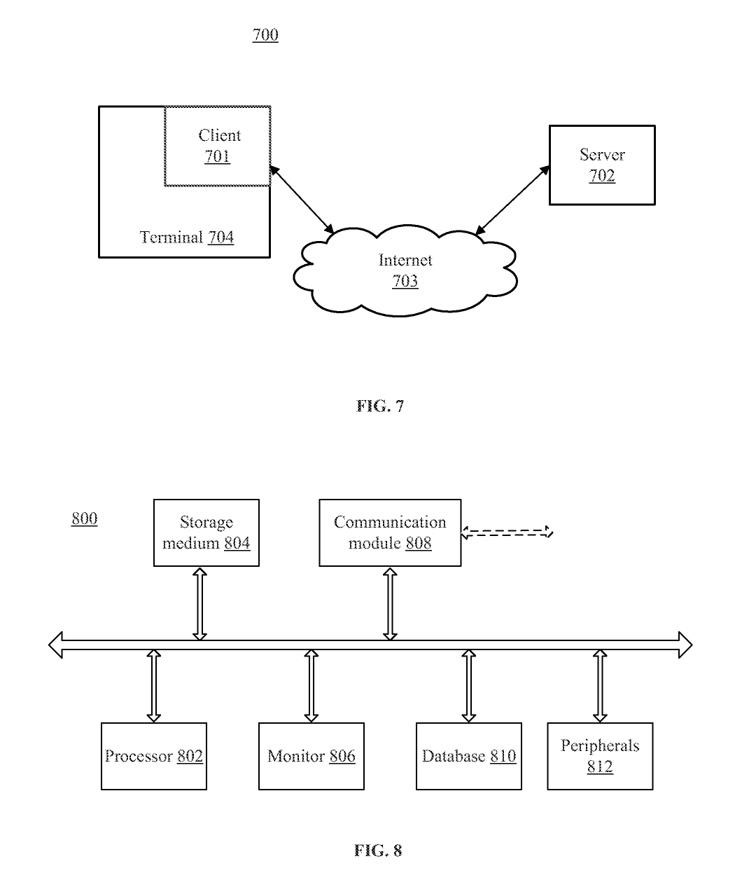

FIG. 7 illustrates an exemplary operating environment 700 incorporating certain disclosed embodiments. As shown in FIG. 7, environment 700 may include a terminal 704, the Internet 703, and a server 702. The Internet 703 may include any appropriate type of communication network for providing network connections to the terminal 704 and the server 702. For example, Internet 703 may include the Internet or other types of computer networks or telecommunication networks, either wired or wireless.

A server, as used herein, may refer to one or more server computers configured to provide certain server functionalities to provide certain personalized services. A server may also include one or more processors to execute computer programs in parallel.

The server 702 may include any appropriate server computers configured to provide certain server functionalities, such as a web browsing functionality, or other application server. Although only one server is shown, any number of servers can be included. The server 702 may be operated in a cloud or non-cloud computing environment.

Terminal 704 may include any appropriate type of computing or mobile computing devices, such as mobile phones, smart phones, tablets, notebook computers, or any type of computing platform. Terminal 704 may include one or more clients 701. The client 701, as used herein, may include any appropriate application software, hardware, or a combination of application software and hardware to achieve certain client functionalities. For example, client 701 may include a browser. According to actual needs in different terminals, a client may be a browser installed on the terminal for browsing, including various types of existing and future browser installed on terminals. Although only one client 701 is shown in the environment 700, any number of clients 701 may be included.

Terminal 704 and/or server 702 may be implemented on any appropriate computing platform. FIG. 8 illustrates a block diagram of an exemplary computer system 800 capable of implementing terminal 704 and/or server 702.

As shown in FIG. 8, computer system 800 may include a processor 802, a storage medium 804, a monitor 806, a communication module 808, a database 810, and peripherals 812. Certain devices may be omitted and other devices may be included.

Processor 802 may include any appropriate processor or processors. Further, processor 802 can include multiple cores for multi-thread or parallel processing. Storage medium 804 may include memory modules, such as Read-only memory (ROM), Random Access Memory (RAM), flash memory modules, and erasable and rewritable memory, and mass storages, such as CD-ROM, U-disk, and hard disk, etc. Storage medium 804 may store computer programs for implementing various processes, when executed by processor 802.

Further, peripherals 812 may include I/O devices such as keyboard and mouse, and communication module 808 may include network devices for establishing connections through the communication network. Database 810 may include one or more databases for storing certain data and for performing certain operations on the stored data, such as database searching.

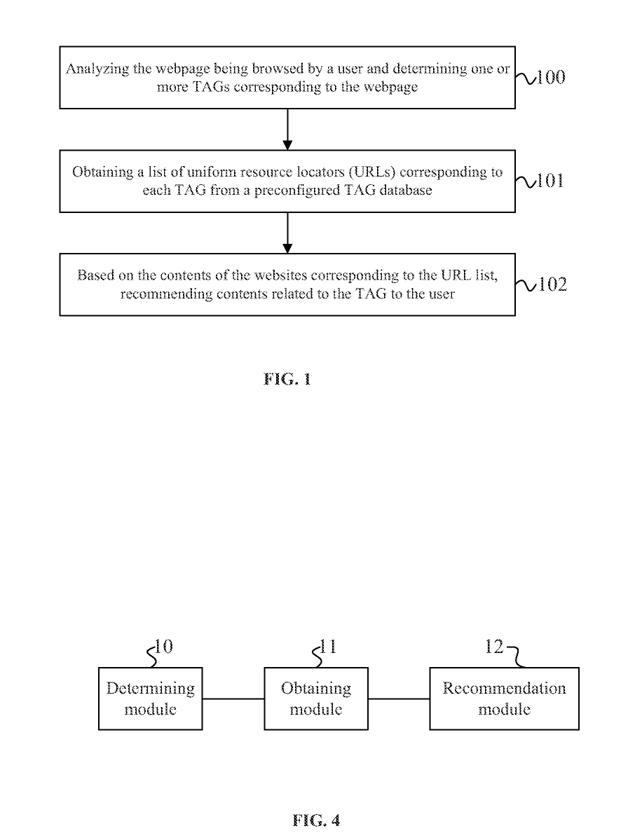

In operation, the terminals/clients and/or servers may provide a browser content recommendation service to a user of the terminal. FIG. 1 illustrates a flow diagram of an exemplary content recommendation process consistent with the disclosed embodiments.

As shown in FIG. 1, the content recommendation process may include the following steps.

Step 100: analyzing the webpage being browsed by a user and determining one or more TAGs corresponding to the webpage. A TAG, as used herein, may be considered as a topic keyword or a label for identifying webpage contents, characteristics, and/or other properties. The TAG may also be referred as a keyword for searching. However, a TAG is not a general keyword in that the TAG may be used for contents that do not include the TAG itself as a keyword.

The TAG may be used for news integration or syndication. News integration may refer to aggregating news contents having same attributes according to a specific dimension, such as news contents with the same or similar TAG (i.e., a TAG dimension).

Step 101: obtaining a list of uniform resource locators (URLs) corresponding to each TAG from a preconfigured TAG database.

Step 102: based on the contents of the websites corresponding to the URL list, recommending contents related to the TAG to the user.

The content recommendation method may be implemented by a content recommendation system, which may be disposed on a terminal, on a server, or a combination of a terminal and a server. For example, a browser client on the terminal may obtain the webpage being browsed by the user and send the webpage to the server, and the server may analyze the webpage being browsed by the user, and determine the TAGs from the webpage. The TAGs may include a single TAG or a plurality of TAGs.

The preconfigured TAG database may be created in advance based on a long-term analysis data. The TAG database may include a plurality of TAGs, and each TAG may correspond to a list of URLs (or other forms of web addresses). The URL list may include multiple URLs, each URL corresponding to a website with contents related to the respective TAG. Further, the URLs on the URL list are obtained across the Internet, and are not limited at any particular website. Thus, the range of the available websites may be significantly improved. The contents of the websites corresponding to the URLs on the URL list are then used to recommend contents related to the TAG to the user.

Thus, according to the disclosed content recommendation methods, TAGs are determined by analyzing the webpage being browsed by the user, one or more URL lists corresponding to the TAGs is obtained from the preconfigured TAG database, and contents related to the TAGs are then recommended to the user based on the contents of the webpages from the websites of the URL list. Such TAG-based content recommendation approach can recommend contents from a variety of websites instead of just from the visiting website. The recommendation scope can be increased, the recommendation effects can be improved, and the recommendation efficiency can be enhanced, improving user experience.

Further, when recommending contents related to the TAGs to the user based on the contents of the websites corresponding to the URL lists, the following steps may be performed.

(1) Linking respectively between the TAG and at least one URLs on the URL list. For example, the title of each website of the at least one URL may be used as the hyperlink linking to the TAG. Thus, when the TAG is clicked by the user, a plurality of hyperlinks can be opened, and each hyperlink corresponding to a website, the title of which being the hyperlink text.

(2) Adding the linked TAG on the webpage being browsed by the user.

(3) Sending the webpage to the browser client. When the user selects the TAG on the webpage through a user interface, the browser client may recommend to the user with the contents from the various websites linked to the TAG.

In this case, links to the relevant websites are recommended to the user by the browser client. When the user opens these websites, contents of the websites related to the TAG as recommended can be obtained. When multiple TAGs are determined, each TAG may be linked to corresponding URLs.

Further, after (1) creating a link respectively between the TAG and at least one URLs on the URL list, and before (2) adding the linked TAG on the webpage, the links between the URLs and the TAG may be sorted according to the user's preference information. Thus, those links between the TAG and the websites having contents preferred by the user can be listed ahead of those links between the TAG and the website having contents less preferred by the user.

The user's preference information may include any appropriate browsing preference information, such as the user's favorite websites, the user's disfavored websites, etc. Further, the user's browsing preference information can also include the user's preference level, i.e., the degrees of the user's preference can be divided into multiple levels from the most disfavored to most favorite. For example, five (5) preference levels may be used. When sorting the websites, the websites with higher preference levels can be listed in the front positions, and the websites with lower preference levels can be listed in lower places.

Alternatively, instead of recommending websites disfavored by the user or websites with lower preference levels, the websites disfavored by the user may be filtered out and unseen by the user based on the user's browsing preference information, and only contents of those websites preferred by the user may be recommended to the user. In such case, after the Step 101 obtaining a list of URLs corresponding to the TAG from a preconfigured TAG database, and before (1) creating a link respectively between the TAG and at least one URL on the URL list, the content recommendation process may also include the followings.

Based on the user's browsing preference information, filtering the URLs on the

URL list to retain at least one URLs corresponding to webpage contents preferred by the user. Thus, only websites with the user's preference may be recommended to the user, and the website with contents not preferred by the user is filtered out. Thus, the recommendation scope can be increased, the recommendation effects can be improved, and the recommendation efficiency can be enhanced, improving user experience.

Further, alternatively, when recommending contents related to the TAG to the user based on the contents of the websites corresponding to the URL list, the following steps may also be performed on each TAG.

(a) Adding the content of at least one website on the URL list to a content integration page (e.g., a news integration page).

(b) Creating a link between the TAG and the website of the content integration page.

(c) Adding the linked TAG on the webpage being browsed by the user.

(d) Sending the webpage to the browser client. When the user selects the TAG on the webpage through a user interface, the browser client recommends the contents of the content integration page linked to the TAG to the user.

In this case, the content integration page is recommended to the user by the browser client, and the content integration page includes contents related to the TAG.

Further, before (a) adding the contents of at least one website on the URL list to a content integration page, the contents of the at least one website are sorted based on the user's browsing preference information, such that the contents preferred by the user are arranged in front of the contents not preferred by the user.

Accordingly, (a) adding the contents of at least one website on the URL list to a content integration page further includes: based on the sorted contents of the at least one website, adding the contents of the at least one website to the content integration page in the sorted order. Thus, the contents preferred by the user are arranged at the front positions and the contents not preferred by the user are arranged at rear positions.

Further, alternatively, the contents of the at least one website may be filtered such that only the contents preferred by the user is added to the content integration page, and the contents not preferred by the user or below a particular preference level are filtered out and not added to the content integration page.

Further, when analyzing the webpage and determining the TAG (Step 100), a time period may be set by the user or by the system. The user's browsing records over the time period may be statistical analyzed to obtain the user's preference information. The time period may be set in advance according to actual needs. For example, the time period may be set as a month or a quarter or half a year, etc., and the statistics of the user's browsing history is obtained over the preset time period.

FIG. 2 illustrates another exemplary content recommendation process by a content recommendation system consistent with the disclosed embodiments. As shown in FIG. 2, the content recommendation process may include the following steps.

Step 200: the content recommendation system collects statistics of the user's browsing history over a preconfigured time period to obtain the user's browsing preference information.

Step 201: when the user is browsing a webpage, the browser client obtains the webpage being browsed by the user.

Step 202: the browser client sends the webpage being browsed by the user to the content recommendation system.

Step 203: the content recommendation system analyzes the webpage being browsed by the user to determine one or more TAGs.

Step 204: the content recommendation system obtains from the TAG database a URL list corresponding to each TAG.

Step 205: the content recommendation system filters the URLs on the URL list based on the user's browsing preference information, and to retain at least one URLs corresponding to webpage contents preferred by the user.

Step 206, the content recommendation system respectively links the at least one URLs with the TAG.

Specifically, the title of the webpage of each URL may be linked to the TAG. For example, if URL ‘A’ has a title ‘B’, when linking URL ‘A’ and the TAG, the TAG can be linked to the title ‘B’ first, and title ‘B’ can then be linked with URL ‘A’. When the user clicks on the TAG, the title ‘B’ can be opened first. The user may view the title ‘B’ first to determine whether to view the contents. If the user determines to view the contents, the user may click on title ‘B’ and the URL ‘A’ is then opened, such that the user can view the contents from the webpage corresponding to URL ‘A’.

Step 207: the content recommendation system adds the linked TAGs in the webpage being browsed by the user.

Step 208: the content recommendation system sends back the webpage with the added TAGs to the browser client.

Step 209: when the user clicks on a linked TAG in the webpage using a user interface, the browser client recommends to the user with the webpage contents corresponding to the URLs linked to the TAG.

Thus, according to the disclosed content recommended methods, by using the content recommendation system to perform topic related content recommendation, the content recommendation can be performed from various ranges of websites, not just the visiting website. Further, personalized content recommendation can be performed based on user's browsing preference information to meet each user's needs and to achieve personalized recommendations for the users, further enhancing the recommendation results.

FIG. 3 illustrates another exemplary content recommendation process by a content recommendation system consistent with the disclosed embodiments. As shown in FIG. 3, the content recommendation process may include the following steps.

Step 300: the content recommendation system collects statistics of the user's browsing history over a preconfigured time period to obtain the user's browsing preference information.

Step 301: when the user is browsing a webpage, the browser client obtains the webpage being browsed by the user.

Step 302: the browser client sends the webpage being browsed by the user to the content recommendation system.

Step 303: the content recommendation system analyzes the webpage being browsed by the user to determine at least one TAGs.

Step 304: the content recommendation system obtains from the TAG database a URL list corresponding to each TAG.

Step 305: based on the user's browsing preference information, the content recommendation system sorts the webpage contents of at least one website corresponding to the URL list, such that the contents preferred by the user is arranged in front of the contents not preferred by the user.

Step 306: based on the sorted webpage contents of the at least one website, the content recommendation system adds the webpage contents to a content integration page. The contents preferred by the user are arranged in front positions on the content integration page, while the contents not preferred by the user are arranged at rear positions on the content integration page.

Step 307: the content recommendation system links the URL of the content integration page URL with the TAG.

Step 308: the content recommendation system adds the linked TAGs in the webpage being browsed by the user.

Step 309: the content recommendation system sends back the webpage with the added TAGs to the browser client.

Step 310: when the user clicks on a linked TAG in the webpage using a user interface, the browser client recommends to the user with the webpage contents of the content integration page linked to the TAG.

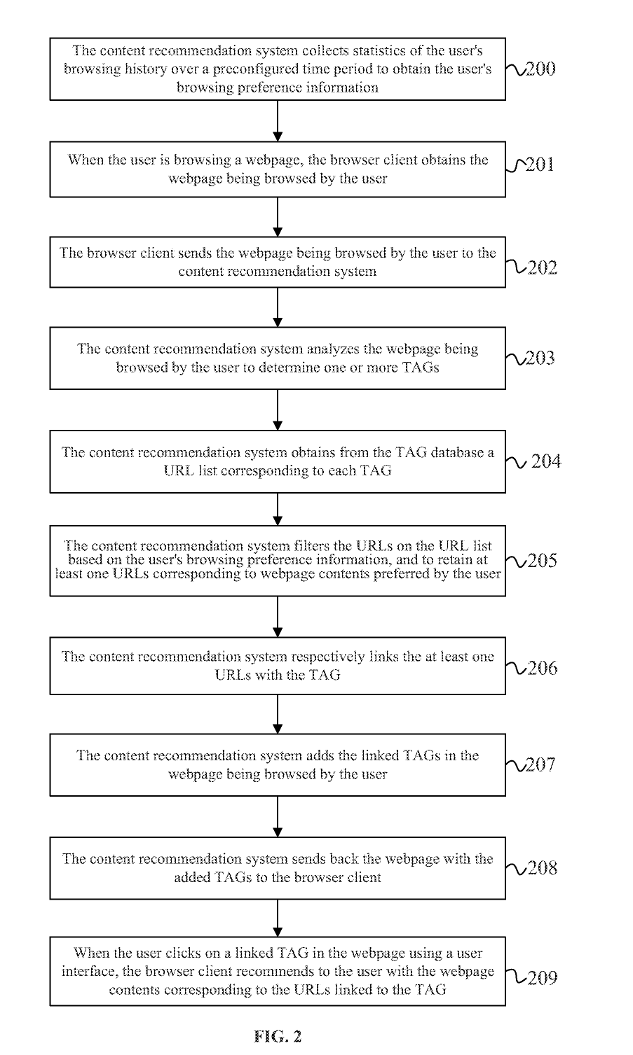

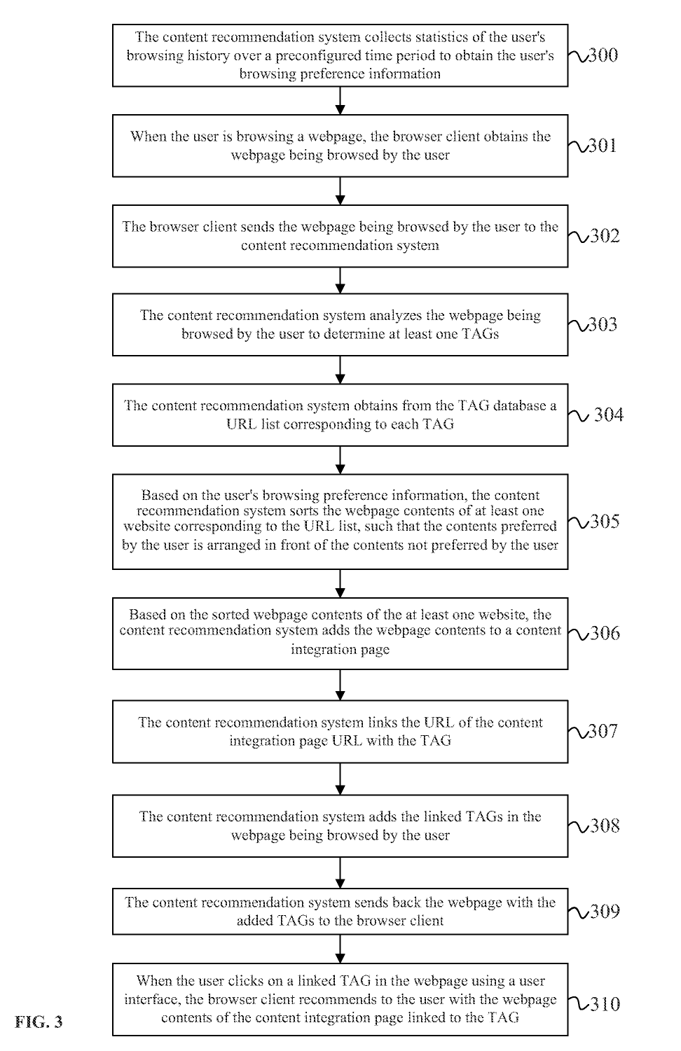

FIG. 4 illustrates an exemplary content recommendation system consistent with the disclosed embodiments. As shown in FIG. 4, the content recommendation system may include a determining module 10, an obtaining module 11, and a recommendation module 12. Other modules may also be included.

The determining module 10 may be configured to analyze the webpage being browsed by the user to determine one or more TAGs. The obtaining module 11 is connected to the determining module 10, and the obtaining module 11 is configured to obtain a URL list from a TAG database corresponding to the TAGs determined by the determining module 10. Further, the recommendation module 12 is connected to the obtaining module 11, and the recommendation module 12 is configured to recommend to the user with contents related to the TAGs based on the webpage contents corresponding to the URLs on the URL list obtained by the obtaining module 11.

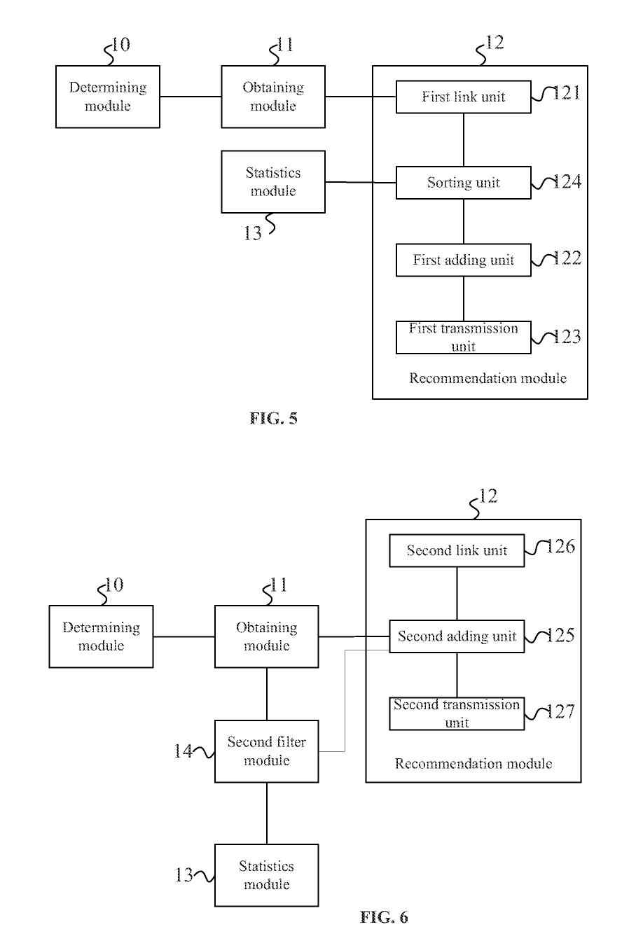

FIG. 5 illustrates an exemplary content recommendation system consistent with the disclosed embodiments. The content recommendation system in FIG. 5 may be based on the content recommendation system in FIG. 4. As shown in FIG. 5, in addition to the determining module 10, the obtaining module 11, and the recommendation module 12, the content recommendation system may include a statistics module 13. Other modules may also be included.

The statistics module 13 may be configured to obtain statistics of the user's browsing records over a preconfigured time period to obtain the user's browsing preference information.

Further, as shown in FIG. 5, the recommendation module 12 may include a first link unit 121, a first adding unit 122, a first transmission unit 123, and a sorting unit 124.

The first link unit 121 is connected with the obtaining module 11, and the first link unit 121 is configured to respectively link each TAG with at least one URLs from the URL list obtained by the obtaining module 11. The first adding unit 122 is connected with the first link unit 121, and the first adding unit 122 is configured to add to the webpage being browsed by the user the linked TAGs created by the first link unit 121. The first transmission unit 123 is connected with the first adding unit 122, and the first transmission unit 123 is configured to send the webpage processed by the adding unit 122 to the browser client, such that, when the user clicks on the linked TAGs in the webpage using a user interface, the browser client recommends to the user with the webpage contents corresponding to the URLs linked to the TAG.

Further, the sorting unit 124 is respectively connected to the first link unit 121 and the first adding unit 122, and the sorting unit 124 is configured to, after the first link unit 121 respectively links the TAG with at least one URLs from the URL list and before the first adding 122 adds the linked TAG to the webpage being browsed by the user, sort the links between the URLs and the TAG according to the user's browsing preference information, such that those links between the TAG and the websites having contents preferred by the user can be listed ahead of those links between the TAG and the website having contents not preferred by the user.

Further, the content recommendation system may include a first filter module (not shown). The first filter module may be arranged in parallel with the sorting unit 124, i.e., it may be unnecessary for the first filter module and the sorting unit 124 to function at the same time with respect to the same TAG.

The first filter module may respectively connected to the determining module 10 and the first link unit 121, and the first filter module is configured to, after the first link unit 121 respectively links the TAG with at least one URLs from the URL list and before the first adding 122 adds the linked TAG to the webpage being browsed by the user, filter the URLs on the URL list to retain at least one URLs corresponding to webpage contents preferred by the user based on the user's browsing preference information. The first link unit 121 may be configured to link the TAG with the at least one URLs from the URL list filtered by the first filter module.

Further, the statistics module 13 is connected to the sorting unit 124 and, the user's browsing preference information obtained by the statistics module 13, the sorting unit 124 sorts the links between the URLs and the TAG created by the first link unit 121, such that those links between the TAG and the websites having contents preferred by the user can be listed ahead of those links between the TAG and the website having contents not preferred by the user.

Further, alternatively, the first filter module is also connected to the statistics module 13 and, based on the user's browsing preference information obtained by the statistics module 13, the first filter module may filter the URLs on the URL list obtained by the obtaining module 11, so as to retain at least one URL corresponding to webpage contents preferred by the user.

FIG. 6 illustrates another exemplary content recommendation system consistent with the disclosed embodiments. The content recommendation system in FIG. 6 may also be based on the content recommendation system in FIG. 4. As shown in FIG. 6, in addition to the determining module 10, the obtaining module 11, and the recommendation module 12, the content recommendation system may include a statistics module 13 and a second filter module 14. Other modules may also be included.

The statistics module 13 may be configured to obtain statistics of the user's browsing records over a preconfigured time period to obtain the user's browsing preference information.

Further, as shown in FIG. 6, the recommendation module 12 may include a second link unit 125, a second adding unit 126, and a second transmission unit 127.

The second adding unit 125 is connected with the obtaining module 11, and the second adding unit 125 is configured to add the webpage contents of at least one URLs on the URL list obtained by obtaining module 11 to a content integration page. The second link unit 126 is connected to the second adding unit 125, and the second link unit 126 is configured to respectively link the URL of the content integration page processed by the second adding unit 125 with each TAG. Further, the second adding unit 125 is also configured to add the linked TAG by the second link unit 126 to the webpage being browsed by the user.

The second transmission unit 127 is connected with the second adding unit 125, and the second transmission unit 127 is configured to send the webpage processed by the second adding unit 125 to the browser client, such that, when the user clicks on the TAG in the webpage using a user interface, the browser client recommends to the user with the webpage contents of the content integration page linked to the TAG.

Further, the second filter module 14 is respectively connected to the statistics module 13 and the obtaining module 11, and the second filter module 14 is configured to, after the obtaining module 11 obtains the URL list corresponding to the TAG from the preconfigured TAG database and before the second adding unit 125 adds the webpage contents of at least one URLs from the URL list to the content integration page, filter the URLs on the URL list to retain the at least one URLs corresponding to webpage contents preferred by the user based on the user's browsing preference information obtained by the statistics module 13. The second adding unit 125 is connected to the second filter module 14, and the second adding unit 125 adds the webpage contents of the at least one URLs on the URL list as filtered by the second filter module 14 to the content integration page.

Further, the content recommendation system may include a sorting module (not shown). The sorting module may be respectively connected to the statistics module 13 and the obtaining module 11, and the sorting module is configured to, after the obtaining module 11 obtains the URL list corresponding to the TAG from the preconfigured TAG database and before the second adding unit 125 adds the webpage contents of the at least one URLs from the URL list to the content integration page, sort the webpage contents of the at least one URL on the URL list obtained by the obtaining module 11 based on the user's browsing preference information obtained by the statistics module 13, such that the webpage contents preferred by the user is positioned in front of the webpage contents not preferred by the user. The second adding unit 125 is connected to the sorting module, and the second adding unit 125 adds the webpage contents of the at least one URL on the URL list sorted by the sorting module to the content integration page.

It should be noted that the various modules and units are listed for illustrative purposes, their functionalities may be combined or interchanged, and the modules and units may be implemented on software, hardware, or a combination of software and hardware.

Those skilled in the art should understand that all or part of the steps in the above method may be executed by relevant hardware instructed by a program, and the program may be stored in a computer-readable storage medium such as a read only memory, a magnetic disk, a Compact Disc (CD), and so on.

The embodiments disclosed herein are exemplary only and not limiting the scope of this disclosure. Without departing from the spirit and scope of this invention, other modifications, equivalents, or improvements to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

By using the disclosed methods and systems, TAGs are determined by analyzing the webpage being browsed by the user, one or more URL lists corresponding to the TAGs is obtained from the preconfigured TAG database, and contents related to the TAGs are then recommended to the user based on the contents of the webpages from the websites of the URL list. Such TAG-based content recommendation approach can recommend contents from a variety of websites instead of just from the visiting website. The recommendation scope can be increased, the recommendation effects can be improved, and the recommendation efficiency can be enhanced, improving user experience.

Further, by using the content recommendation system to perform topic related content recommendation, the content recommendation can be performed from various ranges of websites, not just the visiting website. Further, personalized content recommendation can be performed based on user's browsing preference information to meet each user's needs and to achieve personalized recommendations for the users, further enhancing the recommendation results.

What is claimed is:

1. A content recommendation method for a terminal having a browser client, comprising:
analyzing a webpage being browsed by a user and determining one or more TAGs corresponding to the webpage;
obtaining a list of uniform resource locators (URLs) corresponding to the TAGs from a preconfigured TAG database; and
recommending contents related to the TAGs to the user based on the contents of the websites corresponding to the URL list.

2. The method according to claim 1, wherein the recommending contents related to the TAGs to the user further includes:
respectively linking a corresponding TAG with at least one URLs on the URL list;
adding the linked TAG on the webpage being browsed by the user; and
sending the webpage to the browser client, such that, when the user selects the linked TAG on the webpage through a user interface, the browser client recommends to the user with contents from various websites of the at least one URLs linked to the TAG.

3. The method according to claim 2, further including:
sorting the links between the URLs and the TAG according to the user's browsing preference information, such that those links between the TAG and websites having contents preferred by the user is listed ahead of those links between the TAG and websites having contents not preferred by the user.

4. The method according to claim 2, further including:
based on the user's browsing preference information, filtering the URLs on the URL list to retain at least one URL corresponding to webpage contents preferred by the user

5. The method according to claim 1, wherein the recommending contents related to the TAGs to the user further includes:
adding contents of at least one website on the URL list to a content integration page;
linking a corresponding TAG with an URL of the content integration page;
adding the linked TAG on the webpage being browsed by the user; and
sending the webpage to the browser client, such that, when the user selects the linked TAG on the webpage through a user interface, the browser client recommends to the user with contents from the content integration page linked to the TAG.

6. The method according to claim 5, further including:
sorting the contents of the at least one website based on the user's browsing preference information, such that contents preferred by the user are arranged in front of contents not preferred by the user,
wherein adding contents of at least one website on the URL list to a content integration page further includes:
based on the sorted contents of the at least one website, adding contents of at least one website to the content integration page in a sorted order.

7. The method according to claim 5, further including:
based on the user's browsing preference information, filtering the URLs on the URL list to retain at least one URL corresponding to webpage contents preferred by the user

8. The method according to claim 3, further including:
obtaining statistics on the user's browsing records to obtain the user's browsing preference information.

9. A content recommendation system for recommending contents for a terminal having a browser client, comprising:
a determining module configured to analyze a webpage being browsed by a user to determine one or more TAGs corresponding to the webpage;
an obtaining module configured to obtain a list of uniform resource locators (URLs) corresponding to the TAGs from a preconfigured TAG database; and
a recommendation module configured to recommend contents related to the TAGs to the user based on the contents of the websites corresponding to the URL list.

10. The content recommendation system according to claim 9, wherein the recommending contents related to the TAGs to the user further includes:
a first link unit configured to respectively link a corresponding TAG with at least one URLs on the URL list;
a first adding unit configured to add the linked TAG on the webpage being browsed by the user; and
a first transmission unit configured to send the webpage to the browser client, such that, when the user selects the linked TAG on the webpage through a user interface, the browser client recommends to the user with contents from various websites of the at least one URLs linked to the TAG.

11. The content recommendation system according to claim 10, further including:
a sorting unit configured to sort the links between the URLs and the TAG according to the user's browsing preference information, such that those links between the TAG and websites having contents preferred by the user is listed ahead of those links between the TAG and websites having contents not preferred by the user.

12. The content recommendation system according to claim 10, further including:
a first filter module configured to, based on the user's browsing preference information, filter the URLs on the URL list to retain at least one URL corresponding to webpage contents preferred by the user

13. The content recommendation system according to claim 9, wherein the recommending contents related to the TAGs to the user further includes:
a second adding unit configured to add contents of at least one website on the URL list to a content integration page;
a second link unit configured to link a corresponding TAG with an URL of the content integration page, wherein the second adding unit is also configured to add the linked TAG on the webpage being browsed by the user; and
a second transmission unit configured to send the webpage to the browser client, such that, when the user selects the linked TAG on the webpage through a user interface, the browser client recommends to the user with contents from the content integration page linked to the TAG.

14. The content recommendation system according to claim 13, further including:
a sorting module configured to sort the contents of the at least one website based on the user's browsing preference information, such that contents preferred by the user are arranged in front of contents not preferred by the user,
wherein the second adding unit is further configured to, based on the sorted contents of the at least one website, add contents of at least one website to the content integration page in a sorted order.

15. The content recommendation system according to claim 13, further including:
a second filter module configured to, based on the user's browsing preference information, filter the URLs on the URL list to retain at least one URL corresponding to webpage contents preferred by the user

16. The content recommendation system according to claim 11, further including:
a statistics module configured to obtain statistics on the user's browsing records to obtain the user's browsing preference information.
